(19) United States
(12) Patent Application Publication
(10) Pub. No.: US 2003/0052464 A1
(43) Pub. Date: Mar. 20, 2003

(54) Shopping cart with attached holder for carrying slender elongate items

(76) Inventor: William H. McGuire, Lake Oswego, OR (US)

Correspondence Address: SMITH-HILL AND BEDELL, 12670 N W BARNES ROAD, SUITE 104, PORTLAND, OR, 97229

(21) Appl. No.: 09/957,258

(22) Filed: Sep. 19, 2001

(51) Int. Cl. B62D 39/00

(52) U.S. Cl. 280/33.992

(57) ABSTRACT

A shopping cart has an elongated flexible holder attached lengthwise to the exterior of the shopping cart's basket. The holder conveys long, slender items which are otherwise difficult to fit within the cart's basket. The side of the holder facing the basket has a mesh construction so that items within the holder can be viewed from outside the holder while the outward facing side of the holder is solid in construction making it suitable for the placement of logos, advertisements or other messages.

### BACKGROUND OF THE INVENTION

This invention relates to a shopping cart having a holder for conveying merchandise.

A conventional shopping cart comprises a metal or plastic basket mounted on a wheeled frame. The four walls of the basket typically define a trapezoidal-shaped basket opening which narrows towards the front of the basket. A handle attached to an upper edge of the rear wall of the basket is used to control the cart. The cart's basket often includes a folding shelf attached to an upper part of the rear wall. When folded down the shelf forms a secondary basket-like container spanning the rear wall of the basket. This secondary container is frequently used as a seat for a child. Typically the rear wall of the basket is hinged at the top so that it can fold inward with respect to the basket. This feature allows carts to be nested together for storage by pushing the basket of one cart through the rear wall of another cart.

A customer using the cart to shop for merchandise at a retail store typically loads the basket with a series of items of various shapes and sizes. Small items can be placed on the folding shelf while larger, rectangularly shaped and shorter, cylindrically shaped items can be placed within the basket. The customer should exercise caution as they place each newly selected item into the basket if they are to avoid damaging that item and/or the items already in the basket. When the customer tries to load the basket with a slender item which is too long to fit lengthwise in the basket, the customer often places that item diagonally across the basket. However, a long, slender item lying diagonally across the basket effectively reduces the cart's carrying capacity by making it harder for the customer to place additional items in the basket. This is especially true if the long, slender item is fragile enough that other items cannot be placed on top of it. If the slender item is too long to fit diagonally within the basket then that item will tend to protrude from the basket at an awkward angle and roll about as the cart is moved. Thus when a very long, slender and fragile item such as a fluorescent light bulb is placed in the basket of a conventional shopping cart that item not only impairs the carrying capacity of the cart but is also easily damaged as the customer maneuvers the cart around the store. Further, instability of the long and slender item in the basket poses a risk of injury to the customer who is maneuvering the cart and to other personnel in the store in the event that the item shifts within the basket.

### SUMMARY OF THE INVENTION

In accordance with a first aspect of the invention there is provided a shopping cart comprising a basket and an elongate, flexible holder for conveying slender elongate objects, the basket having first and second side walls and the holder being attached to the basket and located adjacent the first side wall and exteriorly to the basket.

In accordance with a second aspect of the invention there is provided a shopping cart comprising a basket and an elongate, flexible tubular holder for conveying slender elongate objects, the basket having first and second side walls, the holder being attached to the basket and located adjacent the first side wall and exteriorly to the basket and the holder extending lengthwise along said first side wall.

In a preferred embodiment the holder is made out of fabric and is constructed so that objects contained within the holder may be viewed through an inward facing side wall of the holder and so that an outward facing side wall of the holder has an outer surface suitable for bearing a logo, advertisement or other message.

### BRIEF DESCRIPTION OF THE DRAWINGS

For a better understanding of the invention, and to show how the same may be carried into effect, reference will now be made, by way of example, to the accompanying drawings, in which

FIG. 1 is a perspective view of a shopping cart in accordance with the invention having a holder affixed to a side wall of the shopping cart,

FIG. 2 is a side elevation view of the cart of FIG. 1 showing an outward facing side of the holder, and

FIG. 3 is another side elevation view of the cart of FIG. 1 showing an inward facing side of the holder.

### DETAILED DESCRIPTION

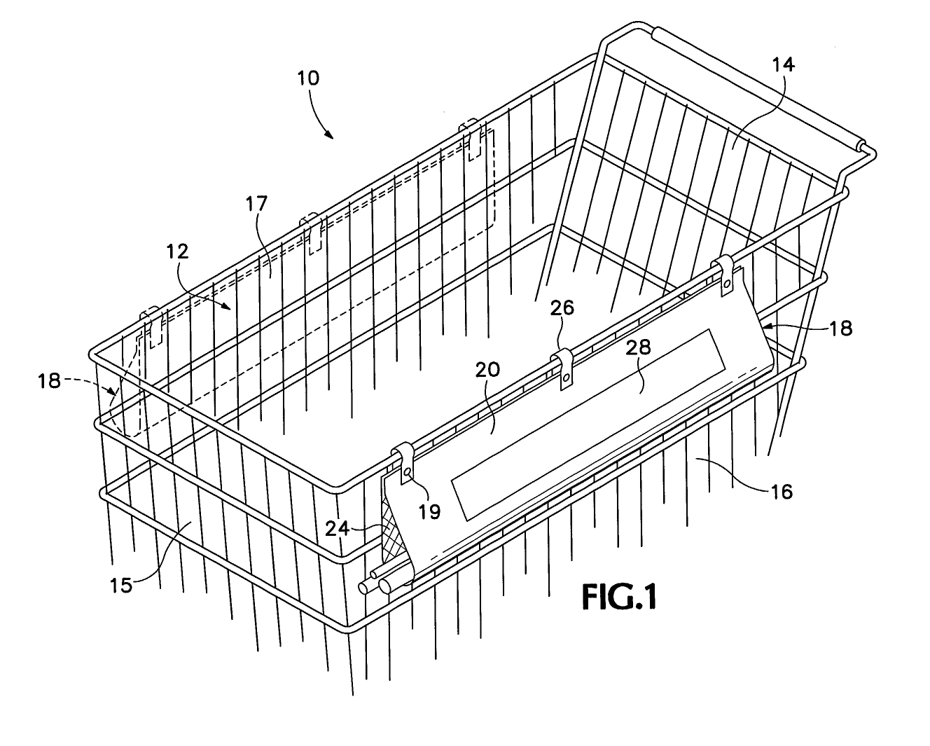

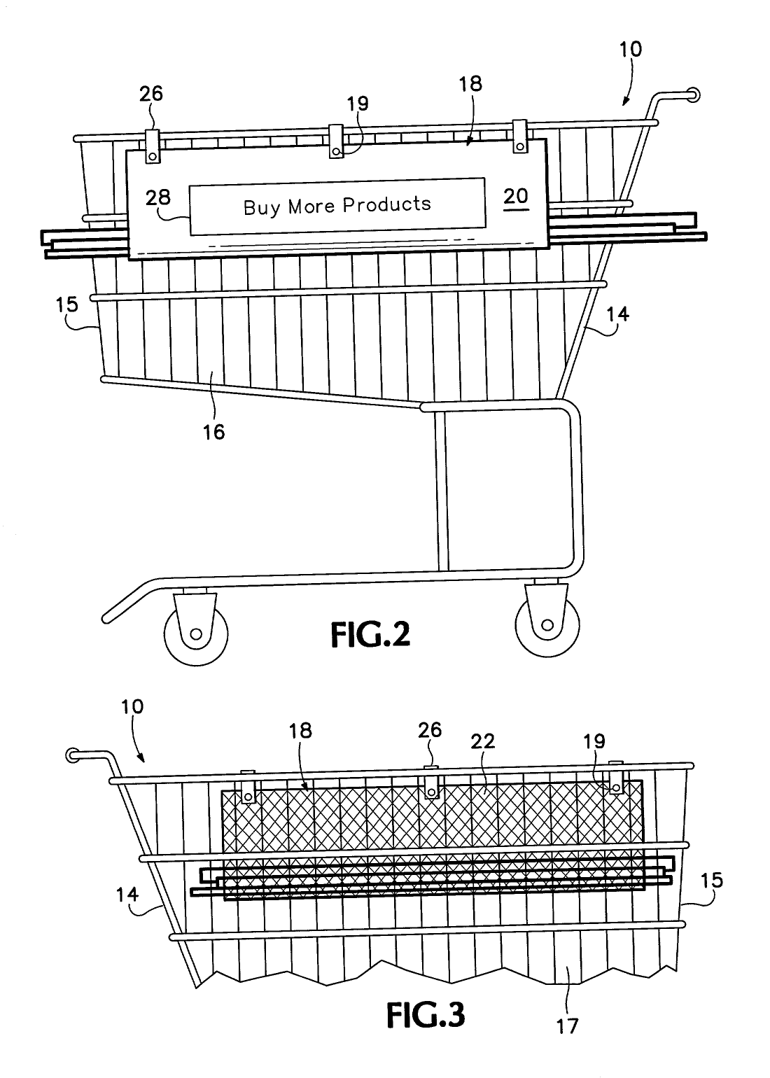

FIG. 1 is a perspective view illustrating a shopping cart 10 in accordance with the invention having a basket 12 formed by a rear wall 14, a front wall 15, side walls 16 and 17 which converge towards front wall 15; and a holder 18 attached lengthwise to side wall 16. FIGS. 2 and 3 are elevation views of cart 10 of FIG. 1 showing an outward facing side 20 and an inward facing side 22 of holder 18.

Holder 18, preferably constructed from fabric or a similarly pliable material and formed into a tubular shape held together by grommets 19, has an opening 24 defined by sides 20 and 22. Cable ties 26 or similar means secure holder 18 to side wall 16 of basket 12. Preferably, side 22 of holder 18 is formed from a fabric mesh or a similar, partially transparent material so that items residing within holder 18 may be viewed from outside the holder. In addition, side 20 of holder 18 is preferably solid in construction so that a commercial advertisement 28 or other message can be placed on it.

When a customer uses cart 10 the customer places those items which are too long to be conveniently held within basket 12 into holder 18 through opening 24. Holder 18 secures those items outside basket 12 thus allowing the customer to load the interior of the basket with other items without fear of damaging the items carried in holder 18. Holder 18 also secures the items it carries against excessive motion relative to basket 12. Thus, the items in the holder are protected against damage and any risk of injury to personnel in the store is reduced compared with the case in which such items are placed in the basket.

Rear wall 14 of basket 12 is hinged at the top so that it swings forwards towards front wall 15. This action, combined with the convergence of side walls 16 and 17 in the direction of front wall 15, permits cart 10 to be stored with similar carts by nesting basket 12 within the basket of another cart. Since holder 18 is constructed out of flexible material such as fabric it does not interfere with and is not damaged by the nesting of basket 12 within another cart's basket.

It will be appreciated that the invention is not restricted to the particular embodiment that has been described, and that variations may be made therein without departing from the scope of the invention as defined in the appended claims and equivalents thereof. For example, although the invention has been described with reference to a shopping cart provided with a holder adjacent only one side wall of the basket, in a modification the cart may be provided with a holder adjacent each side wall of the basket as shown in dashed lines if FIG. 1. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

What is claimed is:

1. A shopping cart comprising a basket and an elongate, flexible holder for conveying slender elongate objects, the basket having first and second side walls and the holder being attached to the basket and located adjacent the first side wall and exteriorly to the basket.

2. A shopping cart according to claim 1, wherein the holder is formed out of fabric.

3. A shopping cart according to claim 1, wherein the holder has a first side wall adjacent to said first side wall of the basket, wherein said first side wall of the holder is at least partially transparent whereby objects contained within the holder may be viewed through the first side wall of the holder.

4. A shopping cart according to claim 3, wherein the first side wall of the holder has an open mesh construction.

5. A shopping cart according to claim 3, wherein the holder has a second side wall spaced from the first side wall of the holder and wherein said second side wall of the holder has an outer surface capable of bearing a message.

6. A shopping cart according to claim 1, wherein the basket has a front wall and wherein the side walls of the basket converge towards the front wall whereby the baskets of two carts may be nested.

7. A shopping cart according to claim 1, further comprising a second holder attached to the basket and located adjacent the second side wall and exteriorly to the basket.

8. A shopping cart comprising a basket and an elongate, flexible tubular holder for conveying slender elongate objects, the basket having first and second side walls, the holder being attached to the basket and located adjacent the first side wall and exteriorly to the basket and the holder extending lengthwise along said first side wall.

9. A shopping cart according to claim 8, wherein the holder is formed out of fabric.

10. A shopping cart according to claim 8, wherein the holder has a first side wall adjacent to said first side wall of the basket, wherein said first side wall of the holder is at least partially transparent whereby objects contained within the holder may be viewed through the first side wall of the holder.

11. A shopping cart according to claim 10, wherein the first side wall of the holder has an open mesh construction.

12. A shopping cart according to claim 10, wherein the holder has a second side wall spaced from the first side wall of the holder and wherein said second side wall of the holder has an outer surface capable of bearing a message.

13. A shopping cart according to claim 8, wherein the basket has a front wall and wherein the side walls of the basket converge towards the front wall whereby the baskets of two carts may be nested.

14. A shopping cart according to claim 8, further comprising a second holder attached to the basket and located adjacent the second side wall and exteriorly to the basket.
